(19) United States
(12) Patent Application Publication
(10) Pub. No.: US 2008/0302017 A1
(43) Pub. Date: Dec. 11, 2008

(54) Window Latch

(76) Inventor: Jim Phillips, Urbana, IL (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/810,222

(22) Filed: Jun. 5, 2007

(51) Int. Cl. E05C 1/08; E05D 15/00; E06B 3/00

(52) U.S. Cl. 49/161; 292/137; 49/506

(57) ABSTRACT

A latch for use in a window with a top sash and a bottom sash. The latch includes a housing with a bottom wall, a pair of opposed sidewalls extending upwardly therefrom, and a rear wall extending upwardly from the bottom wall between the opposed sidewalls. A top edge of each sidewall and a top edge of the rear wall define a first aperture, a front edge of each sidewall and a front edge of the bottom wall define a second aperture, the first aperture and the second apertures form a bolt aperture that opens into a bolt cavity. A pair of opposed guide rails depend inwardly from the top edges of the sidewalls. A bolt is slidably received by the housing, the bolt having a body with a nose, a top and a pair of opposed grooves, the grooves slidably receiving the guide rails. The body is slidably received in the bolt cavity between a first position in which the nose extends outwardly through the second aperture and a second position in which the nose is disposed entirely within the bolt cavity. A peripheral edge of the top of the bolt extends outwardly beyond the top edges of the opposed sidewalls and the rear wall.

### FIELD OF THE INVENTION

The present invention relates generally to window latches. More particularly, the present invention relates to a window latch that may be used to selectively limit the ability to pivot a sash in which the latch is mounted relative to the frame in which the sash is mounted.

### BACKGROUND OF THE INVENTION

Double-hung windows are commonly used in residential and other structures. Double-hung window assemblies typically include a window frame and a pair of window sashes. The bottom sash may be positioned inwardly of the top sash so that the sashes overlap and can be slid vertically relative to one another along the guide rails of the window frame. Window sashes can be made of wood, extruded plastic frame members or metal frame members joined at the corners, for example, to form a generally rectangular frame in which the glazing is installed.

Double-hung windows often include a locking mechanism located at the point where the sashes meet when the window assembly is in a closed position. A latch mechanism may be fixed on the top rail of the bottom sash and the corresponding latch-receiving mechanism is fixed on the bottom rail of the top sash. When the window sashes are in the closed position, the lock may be secured to prevent any movement of the sashes.

Many double-hung windows also include latches (including, for example, tilt latches) that are typically mounted on the opposing ends of the top rail of the bottom sash. The tilt latches generally are manually activated to selectively engage portions of the window frame, for example, grooves formed therein. When in the extended position, the tilt latches engage the window frame, thereby preventing the bottom sash from pivoting motion relative to the window frame, yet allowing the bottom sash to be slid relative to the frame. In the retracted position, the tilt latches allow the bottom sash to be pivoted outwardly from the frame, thus allowing easy access to the outer surface of the panel housed within the bottom sash. Tilt latches can also be incorporated into the top sash to allow similar pivoting motion relative to the window frame.

### SUMMARY OF THE INVENTION

The present invention recognizes and addresses considerations of prior art constructions and methods. In one embodiment of the present invention, a latch for use in a window with a top sash and a bottom sash slidably mounted in a window frame includes a housing comprising a bottom wall, a pair of opposed sidewalls extending upwardly therefrom, a rear wall extending both upwardly from the bottom wall and between the opposed sidewalls. A top edge of each sidewall and a top edge of the rear wall define a first aperture, a front edge of each sidewall and a front edge of the bottom wall define a second aperture, the first aperture and the second aperture forming a bolt aperture that opens into a bolt cavity defined by the housing. A pair of opposed guide rails depend inwardly from the top edges of the sidewalls. A bolt is slidably received by the housing, the bolt including a body with a nose, a top and a pair of opposed grooves extending along the bolt between the body and the top, wherein the grooves slidably receive the guide rails. The body is slidably received in the bolt cavity between a first position in which the nose of the body extends outwardly through the second aperture and a second position in which the nose is disposed entirely within the bolt cavity. A peripheral edge of the top of the bolt extends outwardly beyond the top edges of the opposed sidewalls and the rear wall.

Another embodiment of the invention includes a window assembly with a window frame, a top sash and a bottom sash, the bottom sash being slidably mounted in the window frame, and a latch disposed in the bottom sash. The latch includes a housing comprising a bottom wall, a pair of opposed sidewalls extending upwardly therefrom, and a rear wall extending both upwardly from the bottom wall and between the opposed sidewalls. A top edge of each sidewall and a top edge of the rear wall define a first aperture. A front edge of each sidewall and a front edge of the bottom wall define a second aperture, the first aperture and the second aperture forming a bolt aperture that opens into a bolt cavity defined by the housing. A pair of opposed guide rails depend inwardly from the top edges of the sidewalls. A bolt is slidably received by the housing, the bolt including a body with a nose, a top and a pair of opposed grooves extending along the bolt between the body and the top, wherein the grooves slidably receive the guide rails. The body is slidable in the bolt cavity between a first position in which the nose of the body extends outwardly through the second aperture and a second position in which the nose is disposed entirely within the bolt cavity. The housing of the latch is mounted in the bottom sash such that the top edges of the sidewalls and the top edge of the rear wall lie in a plane that includes an outer surface of the bottom sash.

Yet another embodiment of the invention provides a method of making a latch for use in a window with a top sash and a bottom sash slidably mounted in a window frame. The method includes providing a housing having a bottom wall, a pair of opposed sidewalls extending upwardly therefrom, and a rear wall extending both upwardly from the bottom wall and between the opposed sidewalls. A top edge of each sidewall and a top edge of the rear wall define a first aperture. A front edge of each sidewall and a front edge of the bottom wall define a second aperture, the first aperture and the second aperture forming a bolt aperture that opens into a bolt cavity defined by the housing. A pair of opposed guide rails depend inwardly from the top edges of the sidewalls. The method also includes providing a bolt that is slidably received by the housing, the bolt having a body with a nose, a top and a pair of opposed grooves extending along the bolt between the body and the top. The grooves slidably receive the guide rails and the body is slidable in the bolt cavity between a first position in which the nose of the body extends outwardly through the second aperture and a second position in which the nose is disposed entirely within the bolt cavity. A peripheral edge of the top of the bolt extends outwardly beyond the top edges of the opposed sidewalls and the rear wall.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a window with an embodiment of a latch according to the present invention, installed in the bottom sash of the window;

FIGS. 2A and 2B are perspective views of the window latch as shown in FIG. 1 with the bolt in the extended and retracted positions, respectively;

FIG. 3 is a top view of the housing of the window latch as shown in FIG. 1;

FIG. 4 is a bottom view of the housing of the window latch as shown in FIG. 1;

FIG. 5 is a perspective view of the housing of the window latch as shown in FIG. 1;

FIG. 6 is a top view of the bolt of the window latch as shown in FIG. 1;

FIG. 7 is a bottom view of the bolt of the window latch as shown in FIG. 1;

FIG. 8 is a side view of the bolt of the window latch as shown in FIG. 1;

FIG. 9 is a perspective view of the bolt of the window latch as shown in FIG. 1;

FIG. 10 is an exploded perspective view of the window latch shown in FIG. 1; and

FIG. 11 is a cross-sectional view of the window latch shown in FIG. 1, taken along lines 11-11.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

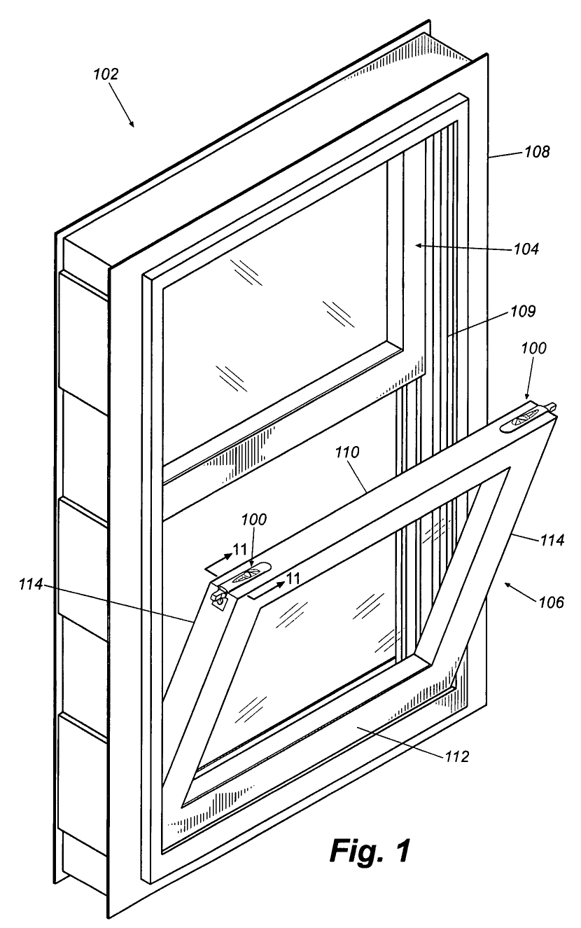

Referring now to FIG. 1, a pair of window latches 100 in accordance with the present invention is shown mounted on an upper surface of a top rail 110 of a bottom sash 106 of a window assembly 102. Bottom sash 106 includes a bottom rail 112 and a pair of styles 114 extending between corresponding ends of top rail 110 and bottom rail 112. As shown, window latches 100 are mounted at opposing ends of top rail 110 so that each is adjacent a vertical member of a window frame 108 of window assembly 102. As such, as discussed in greater detail below, window latches 100 can be used to selectively engage a portion of window frame 108, thereby either allowing or preventing pivoting motion of bottom sash 106 relative to window frame 108.

When window latches 100 engage guide slots 109 formed in the vertical members of window frame 108, bottom sash 106 is limited to being slidably moved within window frame 108. Disengaging both window latches 100 from their respective guide slots 109 enables bottom sash 106 to be pivoted outwardly from window frame 108, as shown in FIG. 1. In the position shown, bottom rail 112 of bottom sash 106 remains vertically slidable within window frame 108. In the preferred embodiment shown, either top sash 104, bottom sash 106, or both sashes, may be slidably moved within window frame 108, such that a ventilation space is created at the top, bottom, or top and bottom, of window assembly 102, respectively. As well, top sash 104 may be pivoted relative to window frame 108 in a manner similar to that which is described below for bottom sash 106.

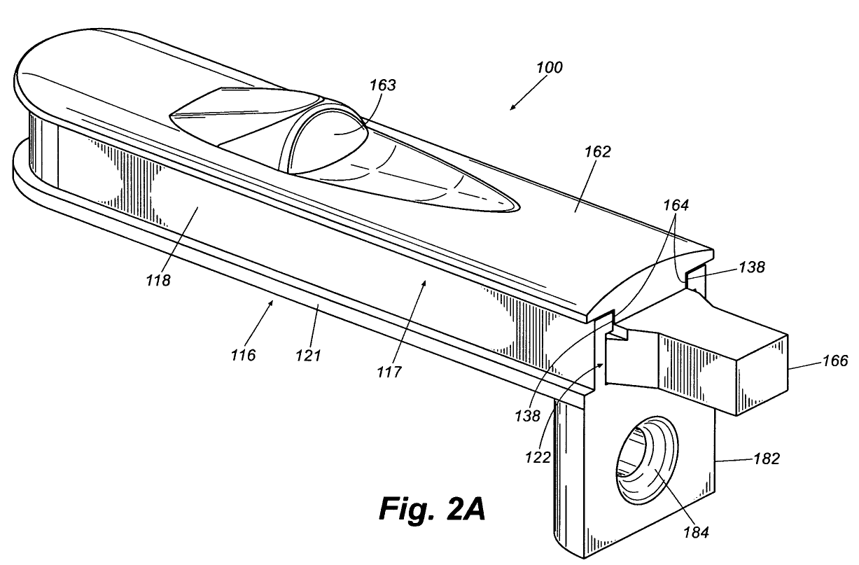

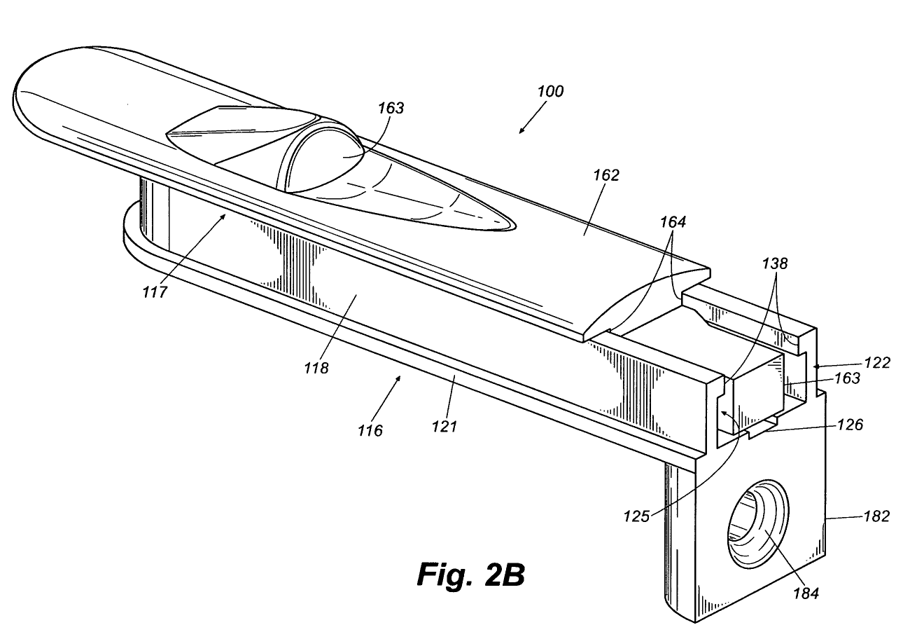

Referring to FIGS. 2A and 2B, a preferred embodiment of window latch 100 includes a housing 116 and a latch bolt 117 slidably mounted therein. FIG. 2A shows window latch 100 with latch bolt 117 in a first position in which a nose 166 of latch bolt 117 extends outwardly beyond a front aperture 122 of housing 116. In this position, nose 166 of latch bolt 117 can engage its respective guide slot 109 (FIG. 1) of window frame 108. As such, window latch 100 prevents pivotal motion of bottom sash 106 relative to window frame 108 while still allowing relative sliding motion of bottom sash 106 relative to top sash 104 within window frame 108. FIG. 2B shows window latch 100 with latch bolt 117 in a second position in which a body 160 (FIG. 8) of latch bolt 117 is retracted into a bolt cavity 125 defined by housing 116. So positioned, nose 166 of latch bolt 117 no longer extends outwardly through front aperture 122 and, therefore, no longer engages its respective guide slot 109 of window frame 108. As such, bottom sash 106 may now be pivoted outwardly from window frame 108.

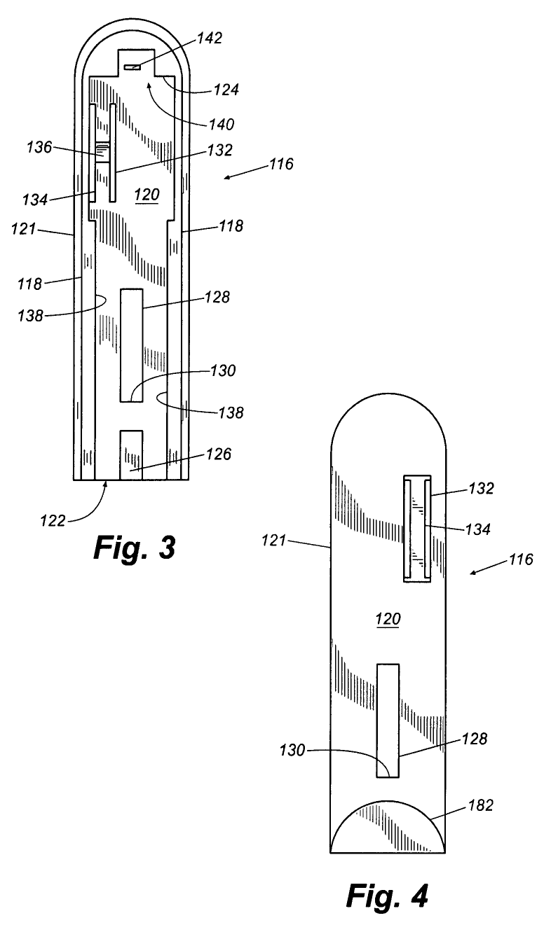

Referring now to FIGS. 3 through 5, housing 116 includes a pair of opposed sidewalls 118, a bottom wall 120 and a back wall 124. Sidewalls 118 are parallel to each other and extend upwardly from a top surface of bottom wall 120 such that each sidewall is perpendicular to bottom wall 120. Back wall 124 extends upwardly from the top surface of bottom wall 120 and also extends between respective ends of opposed sidewalls 118. Each opposed sidewall 118 includes a top edge 118a that lies in a plane (not shown) that is parallel to the top surface of bottom wall 120. Similarly, back wall 124 includes a top edge 124a that is coplanar with top edges 118a of opposed sidewalls 118. As well, each sidewall 118 includes a front edge 118b that lies in a plane (not shown) that includes a front edge 120b of bottom wall 120. The plane in which the front edges of opposed sidewalls 118 and bottom wall 120 lie is perpendicular to the top surface of bottom wall 120.

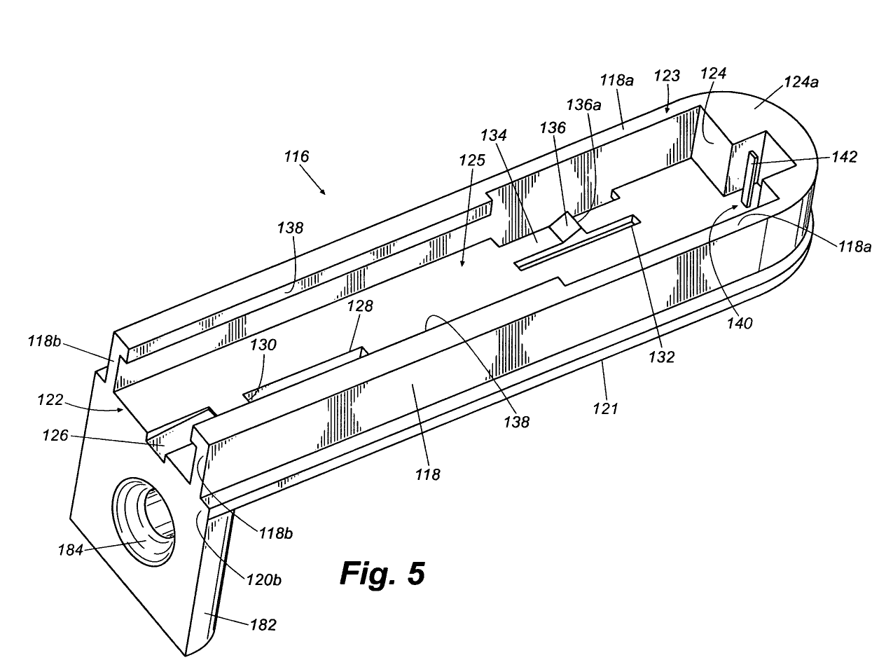

As best seen in FIG. 5, opposed sidewalls 118, bottom wall 120 and back wall 124 define a bolt cavity 125 having a rectangular cross-section relative to the longitudinal access of housing 116. Front edges 118b and 120b of sidewalls 118 and bottom wall 120, respectively, form a generally U-shaped front aperture 122 that opens into bolt cavity 125. Top edges 118a and 124a of opposed sidewalls 118 and back wall 124, respectively, form a generally U-shaped top aperture 123 that also opens into bolt cavity 125. Front aperture 122 and top aperture 123 are contiguous at their open ends such that a single aperture is formed that opens into bolt cavity 125.

Bottom wall 120 of housing 116 includes a ramped surface 126, a first longitudinal slot 128 and a second longitudinal slot 132 formed therein. Ramped surface 126 is formed in the top surface of bottom wall 120 and extends rearwardly from front edge 120b along a longitudinal center axis of bottom wall 120. Ramped surface 126 facilitates assembly of window latch 100, as discussed in greater detail below. First longitudinal slot 128 is formed in bottom wall 120 aft of ramped surface 126 and extends rearwardly therefrom along the central longitudinal axis of bottom wall 120. First longitudinal slot 128 includes a front wall 130 and also facilitates assembly of window latch 100. Second longitudinal slot 132 also extends along the central longitudinal axis of bottom wall 120, but is offset therefrom. A planar member 134 is disposed in second longitudinal slot 132 and extends from a front wall to a rear wall thereof. A catch member 136 extends upwardly from a top surface of planar member 134. Planar member 134 is capable of being deflected downwardly within second longitudinal slot 132 such that catch member 136 is similarly deflectable during the operation of window latch 100.

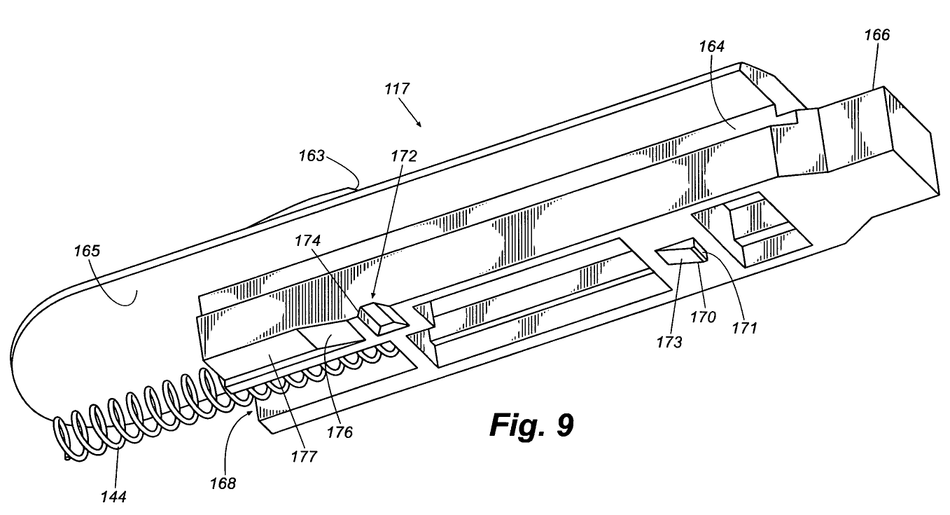

As best seen in FIG. 5, each sidewall 118 includes a guide rail 138 extending along its top edge 118a that depends inwardly into bolt cavity 125. As shown, each guide rail 138 extends rearwardly from front edge 118b of its respective sidewall 118 and ends before reaching back wall 124. However, alternate embodiments include guide rails beginning and ending at various positions along top edges 118a of opposed sidewalls 118b. Back wall 124 defines a recess 140 that extends from the top surface of bottom wall 120 to top edge 124a of back wall 124. A post 142 extends upwardly from the top surface of bottom wall 120 and is disposed within recess 142. Post 142 is configured to secure an end of a biasing member 144 (FIG. 9) in recess 142 when assembling latch bolt 100.

A mounting post 182 extends downwardly from a bottom surface of bottom wall 120 and includes a mounting aperture 184. Mounting aperture 184 extends rearwardly from the front face of mounting post 182 and is parallel to the central longitudinal access of housing 116. Mounting post 182 is configured to be received in a correspondingly shaped recess formed in its respective sash (bottom sash 106, as shown in FIG. 1) so that a threaded fastener (not shown) can be used to secure housing 116 to the sash. An outer periphery of bottom wall 120 forms a mounting ledge 121 that extends outwardly beyond the outer surfaces of opposed sidewall 118 and back wall 124. Mounting ledge 121 is configured to be slidably received by a correspondingly shaped groove 192 (FIG. 11) formed in the sash in which window latch 100 is to be mounted.

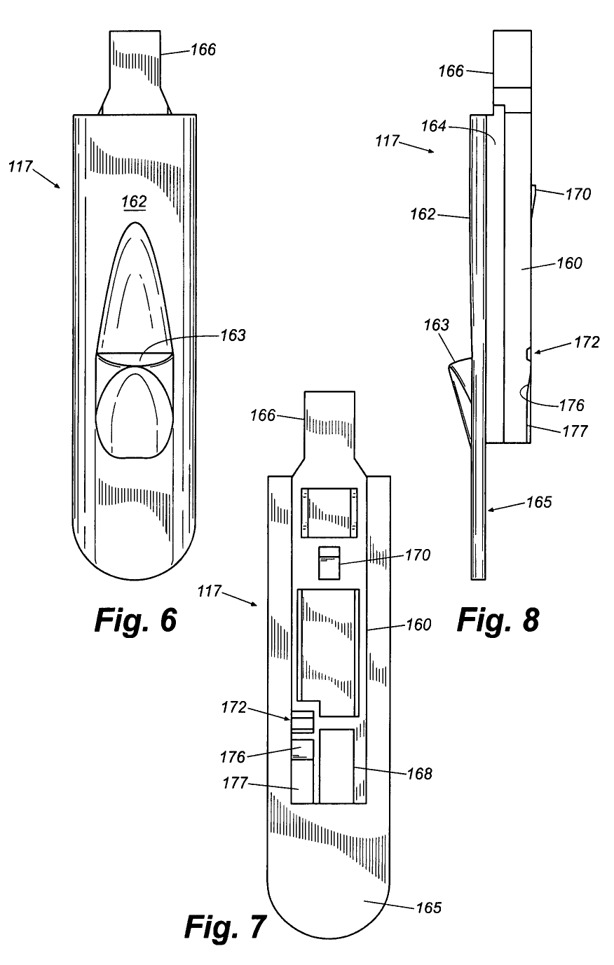

Referring to FIGS. 6 though 9, latch bolt 117 includes a body 160, a top 162, and a pair of opposed grooves 164 formed between body 160 and top 162. Body 160 includes a nose 166 formed at its front end and has a rectangular cross-section that corresponds to the rectangular cross-section of bolt cavity 125 defined by housing 116. Opposed grooves 164 are formed between body 160 and top 162 and extend along the entire length of body 160. Each groove 164 is configured to slidably receive a respective guide rail 138 that depends inwardly from a sidewall of housing 116. A recess 168 is defined by the rear portion of body 160 and is configured to receive an end of biasing member 144, shown as a coil spring, and retain biasing member 144 in the desired position within window latch 100 when the latch is operated. As shown, nose 166 is not as wide as body 160. However, alternate embodiments include noses of varying widths, including those where the nose is the same width as the body. The width of nose 166 is based on the width of the groove or aperture in the window frame that the nose is configured to engage.

Latch bolt 117 includes a mounting catch 170 depending downwardly from the bottom surface of body 160. As best seen in FIG. 9, mounting catch 170 includes an abutting surface 171 that faces the front end of body 160 and a ramped surface 173 that faces the rear end of body 160. Ramped surface 173 is configured to cooperate with ramped surface 126 of housing to facilitate the insertion of body 160 into bolt cavity 125 of the housing during the assembly of window latch 100. Abutting surface 171 is substantially perpendicular to the bottom surface of body 160 and is configured to engage front wall 130 of first longitudinal slot 128 after body 160 has been slidably inserted into bolt cavity 125. Although, in the embodiment shown, abutting surface 171 is perpendicular to the bottom surface of body 160, alternate embodiments can include abutting surfaces 171 that are angled rearwardly so that latch bolt 117 can be more readily removed from bolt cavity 125 if desired.

As best seen in FIG. 9, the bottom surface of body 160 also defines a retention recess 172 and a retention groove 177 disposed rearwardly of retention recess 172. Retention groove 177 extends forwardly toward retention recess 172 from the rear end of body 160 and terminates with a camming surface 176. Retention groove 177 is configured to slidably receive catch member 136 (FIG. 5) without causing catch member 136 to be deflected downwardly as latch bolt 117 is slid rearwardly within housing 116 when operating window latch 100. Camming surface 176 is configured to deflect catch member 136 downwardly as it approaches retention recess 172. After catch member 136 passes over camming surface 176, catch member 136 returns to its non-deflected position such that a rear face 136a of catch member 136 abuts a back face 174 of retention recess 172. In the embodiment shown, back face 136a of catch member 136 and back face 174 of retention recess 172 are correspondingly angled. The abutment of back face 136a with back face 174 allows latch bolt 117 to be retained in the second, or retracted, position (FIG. 2B) without a user having to apply a retaining force. However, the corresponding angles of back faces 136a and 174 can be selected such that latch bolt 117 is not retained in the second position unless an operator exerts additional rearward force. Such embodiments would merely provide an indication, such as a click, to the user that latch bolt 117 has been fully retracted relative to housing 116.

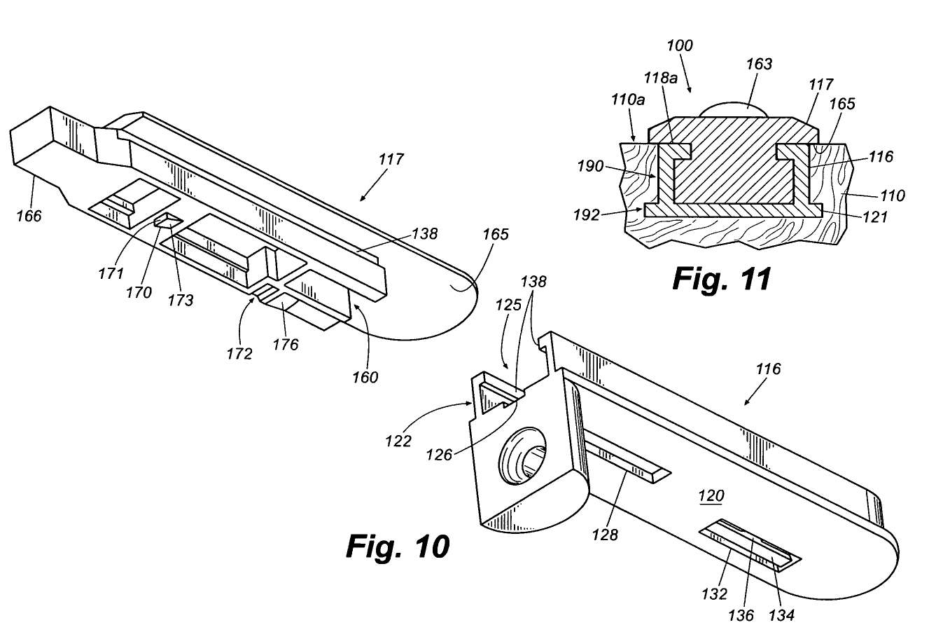

Referring now to FIG. 10, to assemble latch bolt 117 and housing 116 of the preferred embodiment shown, the rear end of body 160 is aligned with front aperture 122 of housing 116 and one end of biasing member 144 is slid downwardly over post 142 (FIG. 5) so that biasing member 144 is retained in housing 116 as window latch 100 as assembled. Note, in alternate embodiments wherein housing 116 does not include post 142, biasing member 144 could first be positioned in either recess 140 of housing 116 or recess 168 of latch bolt 117. Next, body 160 is slidably inserted into bolt cavity 125 such that guide rails 138 are slidably received in their respective grooves 164 on latch bolt 117. As well, as body 160 is slidably received in bolt cavity 125, opposing ends of spring member 144 are maintained in their respective recesses 140 and 168. Body 160 is slid rearwardly within bolt cavity 125 until ramped surface 173 of mounting catch 170 contacts ramped surface 126 of housing, at which point body 160 is urged slightly away from bottom wall 120 of housing 116 as mounting catch 170 first slides along ramped surface 126 and then bottom wall 120. Upon reaching first longitudinal slot 128, mounting catch 170 is received therein and abutting surface 171 of mounting catch 170 engages front wall 130 of first longitudinal slot 128 such that latch bolt 117 is maintained within housing 116. Biasing force exerted on latch bolt 117 by biasing member 144 ensures that latch bolt 117 remains in the first position in which nose 166 of body extends outwardly through front aperture 122 of housing 116 unless a user exerts rearward force on the latch bolt. An actuator 163 extends upwardly from the top of latch bolt 117 so that a user may readily grasp and operate latch bolt 117. Note, although window latch 100 is shown installed in a wooden sash, the latch can also be used in sashes made of extruded plastic frame members and metal frame members as well.

Referring now to FIGS. 1 and 11, the window latch is preferably mounted in a recess 190 formed in bottom sash 106. Recess 190 includes a first portion with a groove 192 formed about its lower periphery that is configured to slidably receive mounting ledge 121 as housing 116 is slidably received in recess 190. Recess 190 also includes a second portion (not shown) that is shaped to receive mounting post 182 therein such that a threaded fastener may be used to secure the window latch in sash 106. Recess 190 is configured such that when window latch 100 is mounted therein, top edges 118a and 124a of sidewalls 118 and back wall 124, respectively, are located in the same plane as top surface 110a of top rail 110. As such, a bottom surface 165 of the top of latch bolt 117 is adjacent top surface 110a of the top rail and slides along top surface 110a as bolt 117 is moved between its first and second positions (FIGS. 2A and 2B). As well, front edges 118b and 120b of sidewalls 118 and bottom wall 120, respectively, are located in the same plane as the outer surface of the respective stile 114. Note, although window latch 100 is shown installed in a wooden sash, latch 100 can also be used in sashes made of extruded plastic frame members and metal frame members.

While one or more preferred embodiments of the invention are described above, it should be appreciated by those skilled in the art that various modifications and variations can be made in the present invention without departing from the scope and spirit thereof. For example, the window latch may be installed in a frame of a window that only has one slidable sash such that motion of the sash relative to the frame may be limited thereby. As well, the window latch be installed in the sash of a window in which the sashes are slid in a horizontally rather than vertically. It is intended that the present invention cover such modifications and variations as come within the scope and spirit of the appended claims and their equivalents.

What is claimed is:

1. A latch for use in a window comprising a top sash and a bottom sash slidably mounted in a window frame, the latch comprising:
a housing comprising a bottom wall, a pair of opposed sidewalls extending upwardly therefrom, a rear wall extending both upwardly from the bottom wall and between the opposed sidewalls, a top edge of each sidewall and a top edge of the rear wall defining a first aperture, a front edge of each sidewall and a front edge of the bottom wall defining a second aperture, the first aperture and the second aperture forming a bolt aperture that opens into a bolt cavity defined by the housing, and a pair of opposed guide rails depending inwardly from the top edges of the sidewalls, and
a bolt slidably received by the housing, the bolt comprising a body with a nose, a top and a pair of opposed grooves extending along the bolt between the body and the top, the grooves slidably receiving the guide rails,
wherein the body is slidably received in the bolt cavity between a first position in which the nose of the body extends outwardly through the second aperture and a second position in which the nose is disposed entirely within the bolt cavity, and
wherein a peripheral edge of the top of the bolt extends outwardly beyond the top edges of the opposed sidewalls and the rear wall.

2. The latch of claim 1, wherein the top of the bolt covers the first aperture when the bolt is in the first position.

3. The latch of claim 1, further comprising:
a mounting slot defined by the bottom wall of the housing, the mounting slot extending along a longitudinal axis of the housing and comprising a front wall disposed adjacent the front edge of the bottom wall, and
a mounting catch depending outwardly from a bottom surface of the bolt,
wherein the mounting catch is slidably received in the mounting slot and engages the front wall of the mounting slot when the bolt is in the first position such that the bolt is retained in the bolt cavity.

4. The latch of claim 1, further comprising:
a catch member extending upwardly from the bottom wall of the housing, and
a retention recess defined by a bottom surface of the bolt,
wherein the catch member engages the retention recess when the bolt is in the second position such that the bolt is selectively retained in the second position.

5. The latch of claim 4, wherein the catch member is deflectable.

6. The latch of claim 5, further comprising:
a slot defined by the bottom wall of the housing, and
an elongated, planar member disposed within the slot and extending between a front end and a rear end thereof,
wherein the catch member is disposed on a top surface of the planar member.

7. The latch of claim 1, further comprising a biasing member disposed between the bolt and the rear wall of the housing, the biasing member being configured to urge the bolt toward the first position.

8. The latch of claim 7, further comprising:
a recess defined by a back end of the body of the bolt, and
a post extending upwardly from the bottom wall of the housing,
wherein a first end of the biasing member is received in the recess and a second end of the biasing member is engaged by the post.

9. The latch of claim 1, wherein the latch is mounted in the bottom sash and the top edges of the sidewalls and the rear wall, and the front edges of the sidewalls and bottom wall, are substantially flush with an outer surface of the bottom sash.

10. The latch of claim 9, wherein the peripheral edge of the top of the bolt is disposed above a portion of the outer surface of the bottom sash.

11. The latch of claim 9, wherein the first and second apertures are generally U-shaped, the first and second apertures being contiguous, thereby forming the bolt aperture.

12. A window assembly comprising:
a window frame;
a top sash and a bottom sash, the bottom sash being slidably mounted in the window frame; and
a latch disposed in the bottom sash, the latch comprising:
a housing comprising a bottom wall, a pair of opposed sidewalls extending upwardly therefrom, a rear wall extending both upwardly from the bottom wall and between the opposed sidewalls, a top edge of each sidewall and a top edge of the rear wall defining a first aperture, a front edge of each sidewall and a front edge of the bottom wall defining a second aperture, the first aperture and the second aperture forming a bolt aperture that opens into a bolt cavity defined by the housing, and a pair of opposed guide rails depending inwardly from the top edges of the sidewalls, and
a bolt slidably received by the housing, the bolt comprising a body with a nose, a top and a pair of opposed grooves extending along the bolt between the body and the top, the grooves slidably receiving the guide rails,
wherein the body is slidable in the bolt cavity between a first position in which the nose of the body extends outwardly through the second aperture and a second position in which the nose is disposed entirely within the bolt cavity, and
wherein the housing of the latch is mounted in the bottom sash such that the top edges of the sidewalls and the top edge of the rear wall lie in a plane that includes an outer surface of the bottom sash.

13. The window assembly of claim 12, wherein a peripheral edge of the top of the bolt extends outwardly beyond the top edges of the opposed sidewalls.

14. The window assembly of claim 12, wherein the latch further comprises:
a mounting slot defined by the bottom wall of the housing, the mounting slot extending along a longitudinal axis of the housing and comprising a front wall disposed adjacent the front edge of the bottom wall, and
a mounting catch depending outwardly from a bottom surface of the bolt,
wherein the mounting catch is slidably received in the mounting slot and engages the front wall of the mounting slot when the bolt is in the first position such that the bolt is retained in the bolt cavity.

15. The window assembly of claim 12, wherein the latch further comprises:
a catch member extending upwardly from the bottom wall of the housing, and
a retention recess defined by a bottom surface of the bolt,
wherein the catch member engages the retention recess when the bolt is in the second position such that the bolt is selectively retained in the second position.

16. The window assembly of claim 15, wherein the catch member is deflectable.

17. The window assembly of claim 16, wherein the latch further comprises:
a slot defined by the bottom wall of the housing, and
a planar member disposed within the slot and extending between a front end and a rear end thereof,
wherein the catch member is disposed on a top surface of the planar member.

18. A method of making a latch for use in a window comprising a top sash and a bottom sash slidably mounted in a window frame, the method comprising:
providing a housing comprising a bottom wall, a pair of opposed sidewalls extending upwardly therefrom, a rear wall extending both upwardly from the bottom wall and between the opposed sidewalls, a top edge of each sidewall and a top edge of the rear wall defining a first aperture, a front edge of each sidewall and a front edge of the bottom wall defining a second aperture, the first aperture and the second aperture forming a bolt aperture that opens into a bolt cavity defined by the housing, and a pair of opposed guide rails depending inwardly from the top edges of the sidewalls, and
providing a bolt that is slidably received by the housing, the bolt comprising a body with a nose, a top and a pair of opposed grooves extending along the bolt between the body and the top, the grooves slidably receiving the guide rails,
wherein the body is slidable in the bolt cavity between a first position in which the nose of the body extends outwardly through the second aperture and a second position in which the nose is disposed entirely within the bolt cavity, and
wherein a peripheral edge of the top of the bolt extends outwardly beyond the top edges of the opposed sidewalls and the rear wall.
